(19) United States
(12) Patent Application Publication
(10) Pub. No.: US 2009/0266904 A1
(43) Pub. Date: Oct. 29, 2009

(54) HVAC SYSTEM WITH ENERGY SAVING MODES SET USING A SECURITY SYSTEM CONTROL PANEL

(75) Inventor: Norman H. Cohen, Suffern, NY (US)

Correspondence Address: CANTOR COLBURN LLP-IBM YORKTOWN, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/108,644

(22) Filed: Apr. 24, 2008

(51) Int. Cl. G05D 23/00

(52) U.S. Cl. 236/51

(57) ABSTRACT

Disclosed is an energy-conserving HVAC system for an occupancy, the system including an HVAC system including HVAC actuators, sensors configured to sense temperature and humidity in zones of the occupancy, and an HVAC controller in communication with the HVAC actuators and the sensors, said HVAC controller being configured to include HVAC modes that specify that each of the HVAC actuators to be actuatable and deactuatable in response to particular HVAC sensor readings in the zones, and a security system configured to provide security, the security system including a security control panel in communication with the HVAC controller, wherein the security system includes security modes that are actuatable via the security control panel, actuation of each of the plurality of security modes resulting in an automatic actuation of the HVAC modes, the automatic actuation occurring without any action beyond the actuation of one of the plurality of security modes.

### BACKGROUND OF THE INVENTION

1. Field of the Invention

The disclosure relates generally to an energy-conserving Heating, Ventilation, and Air Conditioning (HVAC) system, and more particularly to an energy-conserving HVAC system that communicates with a security system.

1. Description of the Background

Setback thermostats have long been used to conserve energy by setting the target temperature for a home based on the time of day. The presumption is that, at certain times of the day, a house is likely to be unoccupied, and can therefore be kept at less comfortable temperatures, reducing the amount of energy that must be expended for heating or cooling. However, time of day is, at best, an imperfect indicator of whether a house is likely to be occupied. Illnesses, holidays, extended trips, sleepover guests, and telecommuting from home are among the circumstances that lead to houses being occupied or unoccupied at atypical times of day.

Most set back thermostats have override mechanisms, but these are often not used, either because they are complicated or because the engaging of the override entails performing an extra action. Accordingly, a system designed such that a user may more easily set a thermostat based on presence of occupants in a house would be desirable.

### SUMMARY OF THE INVENTION

Disclosed is an energy-conserving HVAC system for an occupancy, the system including an HVAC system including at least one HVAC actuator, at least one sensor configured to sense temperature and humidity in at least one zone of the occupancy, and an HVAC controller in communication with the at least one HVAC actuator and the at least one sensor, said HVAC controller being configured to include a plurality of HVAC modes, each of the HVAC modes specifying that each of the at least one HVAC actuator is actuatable and deactuatable in response to particular HVAC sensor readings in the at least one zone of the occupancy, and a security system configured to provide security to the occupancy, the security system including a security control panel in communication with the HVAC controller, wherein the security system includes a plurality of security modes that are actuatable by an occupant via the security control panel, actuation of each of the plurality of security modes by the occupant resulting in an automatic actuation of at least one of the HVAC modes, the automatic actuation occurring without any action by the occupant beyond the actuation of one of the plurality of security modes, wherein the security control panel includes actuators dedicated solely to control of the security system and said HVAC system, control of the HVAC system being accomplished via communication between the security control panel and the HVAC control panel, wherein the actuators are at least one of a plurality of buttons, switches, dials, and knobs, and wherein the HVAC system and the security system are retrofittable onto previously existing security and HVAC systems of the occupancy.

### BRIEF DESCRIPTION OF THE DRAWINGS

The foregoing and other features and advantages of the present invention should be more fully understood from the following detailed description of illustrative embodiments taken in conjuncture with the accompanying Figures in which like elements are numbered alike in the several Figures:

FIG. 1 is a schematic representation of an HVAC system;

FIG. 2 is a schematic representation of the exemplary embodiment of the HVAC system in communication with an exemplary embodiment of a security system;

FIG. 3a is a table illustrating HVAC modes;

FIG. 3b is a flow chart illustrating HVAC modes;

FIG. 4 is a schematic representation of a security control panel in an energy conserving system;

FIG. 5a is a table illustrating security modes; and

FIG. 5b is a flow chart illustrating security modes.

### DETAILED DESCRIPTION OF THE INVENTION

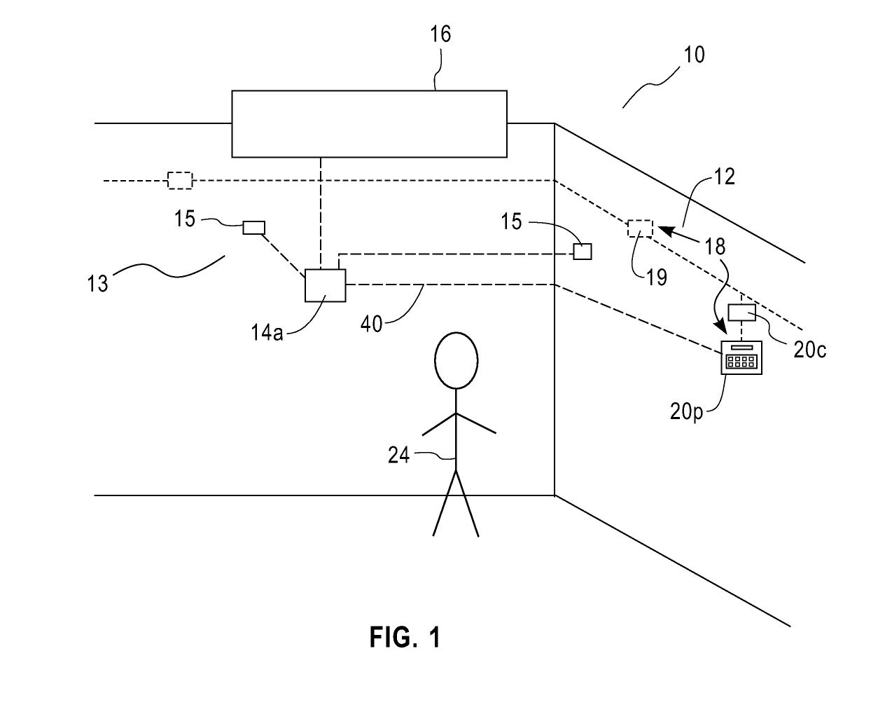

Referring to FIGS. 1, 1a, and 1b, an energy conserving HVAC system 10 for an occupancy 12 is illustrated (it should be noted that for purposes of this Application, the term “occupancy” will be defined as any commercial or residential structure and an “HVAC system” will be defined as a system providing one or more of heating, ventilation, and air-conditioning functions). The system 10 includes an HVAC system 9 and a security system 18. The HVAC system 9 is configured to control at least one of temperature and humidity in the occupancy 12. The HVAC system 9 includes an HVAC controller 14b, at least one sensor 15 configured to sense temperature and/or humidity, and an actuator 16. In an exemplary embodiment, the HVAC controller 14b is a microprocessor running a control program in communication with sensors 15, and HVAC actuators 16. The HVAC actuators 16 may be a water heater, an electric radiator, an air-conditioning compressor, a fan, and a valve, used to heat, ventilate, or air-condition at least one zone 13 of the occupancy 12.

The security system 18 is configured to provide security to the occupancy 12. The security system 18 includes a security controller 20c, a security control panel 20p that is in direct communication with the HVAC controller 14b, and a plurality of sensors 19, which may be perimeter sensors that sense the opening of doors and windows and infrared sensors that sense motion, used in conventional security systems.

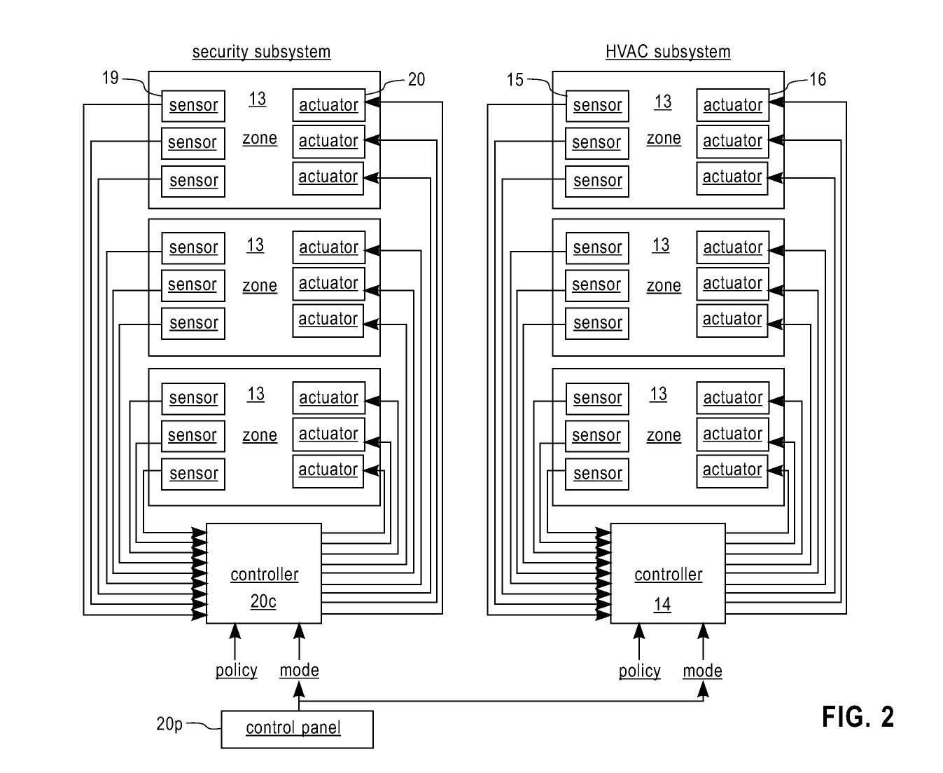

Referring to FIG. 2 in particular, the security system 18, which is shown in a closed loop configuration, includes sensors 19 and actuators 27, wherein the actuators 27 may sound an audible alarm or send an alert to a central monitoring station (not illustrated). In an exemplary embodiment, the security controller 20c is a microprocessor running a control program, wherein a security mode may be determined by a “Deactivated”/“Stay”/“Away” security mode on a control panel (discussed in greater detail later in the disclosure), with a security policy determining which sensed conditions trigger an alarm in which mode.

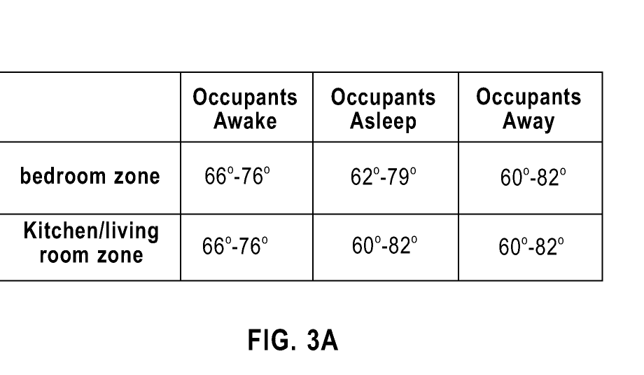

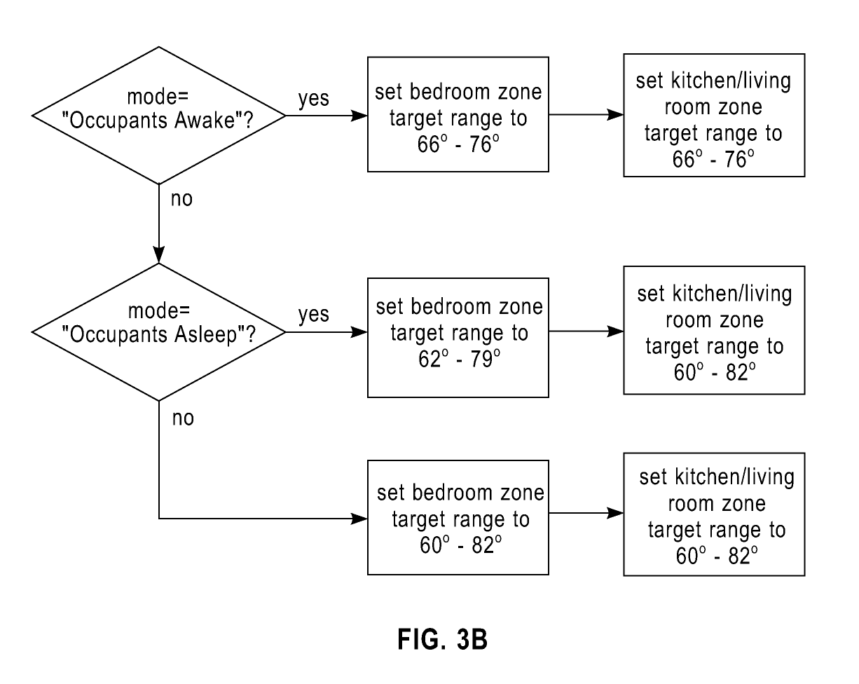

In an exemplary embodiment, the HVAC controller may be in one of several possible HVAC modes. HVAC modes include an Occupants Awake HVAC mode, an Occupants Asleep HVAC mode, and an Occupants Away HVAC mode. The HVAC controller 14b establishes a target temperature range for each zone 13, as shown in FIGS. 3a-b. When a sensor 15 for a particular zone senses a temperature below the target temperature range for that zone, it activates heating actuators 16 for that zone until the sensor 15 senses a temperature higher than the lower end of the target range. When a sensor 15 for a particular zone senses a temperature above the target temperature range for that zone, it activates cooling actuators 16 for that zone until the sensor 15 senses a temperature lower than the upper end of the target range. (Thus wider ranges cause actuators are activated less often, saving energy.) In an exemplary embodiment, an installation technician programs the temperature range corresponding to each HVAC mode into the HVAC controller 14b using the buttons 30 on the security control panel 20p. It will be recognized that there are alternative ways of establishing the temperature range corresponding to each HVAC mode, including fixed ranges built into the HVAC controller 14b, physical controls (such as dials) on the HVAC controller that are set at installation time, and ranges transmitted to the HVAC controller over a computer network, perhaps in response to an occupant 24 specifying temperature preferences on a web page.

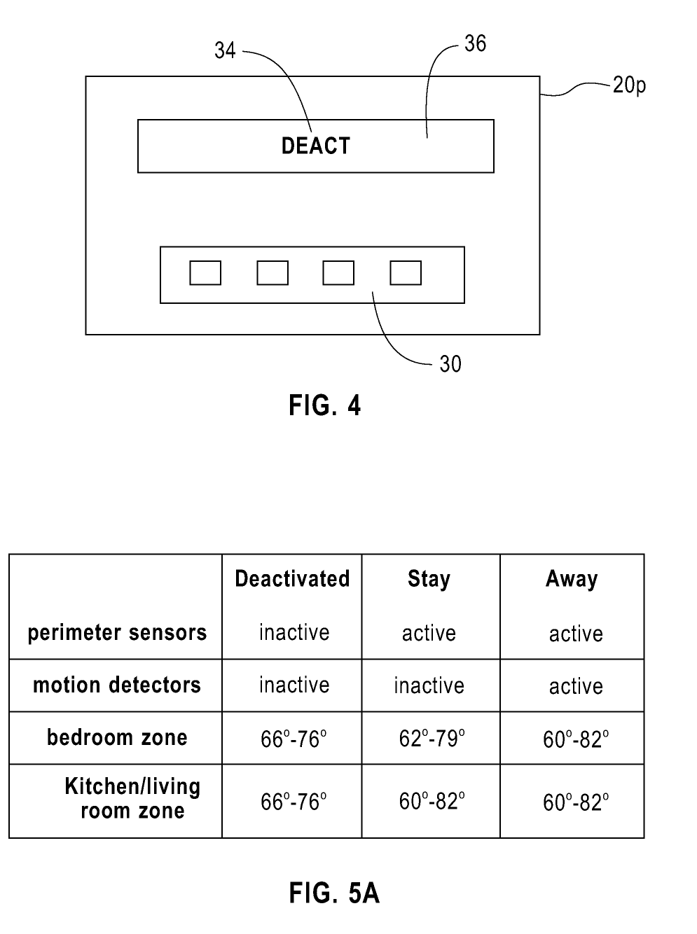

Referring now to FIG. 4, an exemplary embodiment of the security control panel 20p is shown to include various buttons 30 that allow a user 24 to set the security controller 20c to one of a plurality of security modes. In FIG. 4, these security modes are represented by setting 34 (in this exemplary Figure “Deactivated” mode 26), which may be displayed as shown on a unit display screen 36 of the security control panel 20p. Selection of each of the plurality of security modes by the occupant 24 results in an automatic selection of at least one of the above discussed HVAC modes. This automatic selection occurs without any action by the occupant 24 beyond selection of one of the plurality of security modes.

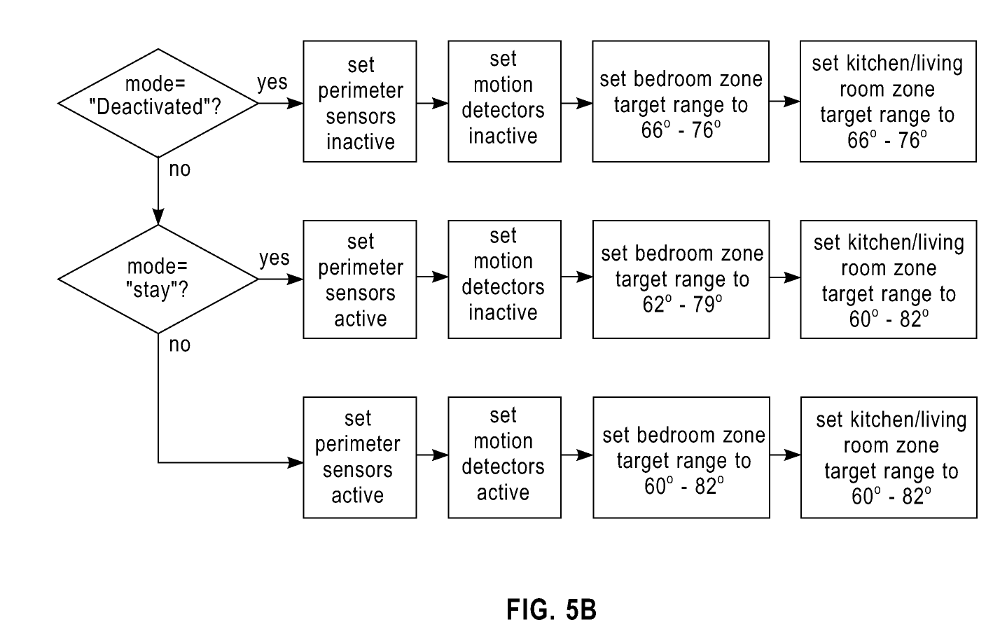

As is shown in the exemplary embodiment of FIGS. 5a-b, the security modes include a Deactivated security mode, a Stay security mode, and an Away security mode. Referring to FIGS. 5a-b, when occupants 24 are present and active in the occupancy 12, one of the users 24 (by matter of course) will have used the security control panel 20p to set the security controller 20c to the Deactivated mode, so as to allow the occupants 24 to open windows and doors and move freely about the occupancy 12 without triggering any detection alarm configured with the system 18. When the security control panel 20p is set to the deactivated security mode, a transmission is automatically communicated to the HVAC controller 14b, wherein the transmission automatically sets the HVAC controller 14b to the Occupants Awake HVAC mode.

When occupants 24 are about to go to sleep in the occupancy 12, one of the users 24 (by matter of course) will use the security control panel 20p to set the security controller 20c to the Stay security mode, which activates perimeter sensors to detect an opening of a door or window, but does not activate motion sensors, so that movement within the occupancy 12 will not trigger an alarm. When the security control panel 20p is set to the Stay security mode, a transmission is automatically communicated to the HVAC controller 14b, wherein the transmission automatically sets the HVAC controller 14b to the Occupants Asleep HVAC mode.

When occupants 24 are not present in the occupancy 12, the last of the users 24 to leave the occupancy 12 (by matter of course) will use the security control panel 20p to set the security controller 20c to the Away security mode, which activates perimeter sensors to detect an opening of a door or window and also activates motion detectors to detect any movement within the occupancy 12. When the security control panel 20p is set to the Away security mode, a transmission is automatically communicated to the HVAC controller 14b, wherein the transmission automatically sets the HVAC controller 14b to the Occupants Away HVAC mode.

With reference to the above description and Figures, it should be noted that any communication (such as communication 40 of FIG. 1) between the and security control panel 20p and the HVAC controller 14b may be achieved via at least one of a wired connection or wireless communication. The communication may be direct, or the security controller 20c may act as an intermediary.

It should also be noted that the HVAC controller 14b and the security controller 20c might be separate devices, or they might be a single device that performs both functions.

It should also be noted that the correspondence between HVAC modes and security modes may be more complicated than the one-to-one correspondence we have illustrated. For example, the number of HVAC modes may be different from the number of security modes. Several security modes may correspond to the same HVAC mode, or some HVAC modes might not correspond to any security mode. Rather than a range of target temperatures, each HVAC mode might correspond to a single target temperature for a heating system, or a single target temperature for a cooling system.

It should also be noted that the automatic setting of the HVAC mode as a result of setting the security mode does not preclude a separate mechanism for setting the HVAC mode manually if that is desired, overriding the automatic setting.

It should further be appreciated that, in an exemplary embodiment, the security control panel 20p includes actuators 30 (which may be buttons, switches, dials, or knobs, any of which being includable in representation on a single display of a touch screen) dedicated solely to control of the security system 18 and ultimately HVAC system 9 (control of the HVAC system being accomplished via communication between the security control panel 20p and HVAC control panel 14b).

It should additionally be appreciated that the system 10 can be retrofitted inexpensively onto previously existing HVAC and security systems, without being built into the house at construction time or requiring a massive replacement of infrastructure. All that is necessary is to tap into the security system to determine the current security setting and to communicate from the tap point to replacement thermostats that set target temperatures according to the current security setting. This is an incremental improvement to existing infrastructure.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or substance to the teachings of the invention without departing from the scope thereof. Therefore, it is important that the invention not be limited to the particular embodiment disclosed as the best mode contemplated for carrying out this invention, but that the invention will include all embodiments falling within the scope of the apportioned claims. Moreover, unless specifically stated any use of the terms first, second, etc. do not denote any order or importance, but rather the terms first, second, etc. are used to distinguish one element from another.

What is claimed is:

1. An energy-conserving HVAC system for an occupancy, said system comprising:
an HVAC system including at least one HVAC actuator, at least one sensor configured to sense temperature and humidity in at least one zone of the occupancy, and an HVAC controller in communication with said at least one HVAC actuator and said at least one sensor, said HVAC controller being configured to include a plurality of HVAC modes, each of said HVAC modes specifying that each of said at least one HVAC actuator is actuatable and deactuatable in response to particular HVAC sensor readings in said at least one zone of the occupancy; and
a security system configured to provide security to the occupancy, said security system including a security control panel that is in direct communication with said HVAC controller,
wherein said security system includes a plurality of security modes that are actuatable by an occupant via said security control panel, actuation of each of said plurality of security modes by said occupant resulting in an automatic actuation of at least one of said HVAC modes, said automatic actuation occurring without any action by said occupant beyond said actuation of one of said plurality of security modes,
wherein said security control panel includes actuators dedicated solely to control of said security system and said HVAC system, control of said HVAC system being accomplished via communication between said security control panel and said HVAC controller, wherein said actuators are at least one of a plurality of buttons, switches, dials, and knobs, and
wherein said HVAC system and said security system are retrofittable onto previously existing security and HVAC systems of the occupancy.

2. The system of claim 1, wherein said at least one HVAC actuator is at least one of a water heater, an electric radiator, an air-conditioning compressor, a fan, and a valve, used to heat, ventilate, or air-condition said at least one zone of the occupancy.

3. The system of claim 1, wherein said security modes include at least a mode for use when said occupants are present and active in the occupancy, a mode for use when said occupants are sleeping in the occupancy, and a for use when said occupants are not present in the occupancy.
